(19) United States
(12) Patent Application Publication
(10) Pub. No.: US 2014/0056211 A1
(43) Pub. Date: Feb. 27, 2014

(54) LATTICE CODING SCHEME FOR TWO-WAY MULTI-RELAY WIRELESS COMMUNICATIONS

(71) Applicant: SAMSUNG ELECTRONICS CO., LTD., Suwon (KR)

(72) Inventors: Yiwei Song, Sunnyvale, CA (US); Huai-Rong Shao, San Jose, CA (US); Chiu Ngo, Millbrae, CA (US)

(73) Assignee: SAMSUNG ELECTRONICS CO., LTD., Suwon (KR)

(21) Appl. No.: 13/970,529

(22) Filed: Aug. 19, 2013

Related U.S. Application Data
(60) Provisional application No. 61/692,044, filed on Aug. 22, 2012.
(60) Provisional application No. 61/727,032, filed on Nov. 15, 2012.

(51) Int. Cl. H04W 88/04

(52) U.S. Cl. CPC H04W 88/04
USPC 370/315

(57) ABSTRACT

One embodiment comprises a method for a relay node. The method comprises receiving a first message combination comprising at least one encoded message from a first neighboring node and at least one encoded message from a second neighboring node. The first message combination is decoded based on one or more decoding constraints. Each decoding constraint is based on a transmission power of a neighboring node. A transform is applied to the decoded first message combination to generate a second message combination for broadcast. The second message combination is scaled based on a transmission power of the relay node and a transmission power of a neighboring node. The scaled second message combination is simultaneously broadcast to the first neighboring node and the second neighboring node at a symmetric rate.

### CROSS-REFERENCE TO RELATED APPLICATIONS

This application claims priority to U.S. Provisional Patent Application Ser. No. 61/692,044, filed on Aug. 22, 2012, and U.S. Provisional Patent Application Ser. No. 61/727,032, filed on Nov. 15, 2012, both of which are incorporated herein by reference.

### TECHNICAL FIELD

One or more embodiments relate generally to relay networks, and in particular, a lattice coding system for a two-way multi-relay network.

### BACKGROUND

A relay network is a type of computer network that is used to send information between two devices, such as a server and a user device (e.g., a mobile phone, a computer, etc.). The two devices represent terminal nodes that cannot communicate directly with each other because the distance between the terminal nodes is greater than the transmission range of both of the terminal nodes. Intermediate relay nodes and hops are used to facilitate communication between the terminal nodes.

### SUMMARY

One embodiment provides a method for a relay node. The method comprises receiving a first message combination comprising at least one encoded message from a first neighboring node and at least one encoded message from a second neighboring node. The first message combination is decoded based on one or more decoding constraints. Each decoding constraint is based on a transmission power of a neighboring node. A transform is applied to the decoded first message combination to generate a second message combination for broadcast. The second message combination is scaled based on a transmission power of the relay node and a transmission power of a neighboring node. The scaled second message combination is simultaneously broadcast to the first neighboring node and the second neighboring node at a symmetric rate.

Another embodiment provides a system comprising a first terminal node and a second terminal node, wherein the terminal nodes are non-neighboring nodes. The system further comprises at least one relay node interconnecting the terminal nodes. Each relay node is configured for decoding a first message combination comprising encoded messages from neighboring nodes based on one or more decoding constraints, applying a transform to the decoded first message combination to generate a second message combination for broadcast, scaling the second message combination based on a transmission power of the relay node and a transmission power of a neighboring node, and simultaneously broadcasting the scaled second message combination to each neighboring node at a symmetric rate. Each decoding constraint is based on a transmission power of a neighboring node.

Another embodiment provides a data relaying apparatus comprising a decoding module configured for decoding a first message combination based on one or more decoding constraints. The first message combination comprises at least one encoded message from a first neighboring node and at least one encoded message from a second neighboring node. The relaying apparatus further comprises a transform module configured for applying a transform to the decoded first message combination to generate a second message combination for broadcast. The relaying apparatus further comprises a scaling module configured for scaling the second message combination based on a transmission power of the relay node and a transmission power of a neighboring node. The scaled second message combination is simultaneously broadcast to the first neighboring node and the second neighboring node at a symmetric rate. Each decoding constraint is based on a transmission power of a neighboring node.

Another embodiment provides a non-transitory computer-readable medium having instructions which when executed on a computer perform a method for a relay node. The method comprises receiving a first message combination comprising at least one encoded message from a first neighboring node and at least one encoded message from a second neighboring node, and decoding the first message combination based on one or more decoding constraints. Each decoding constraint is based on a transmission power of a neighboring node. The method further comprises applying a transform to the decoded first message combination to generate a second message combination for broadcast, scaling the second message combination based on a transmission power of the relay node and a transmission power of a neighboring node, and simultaneously broadcasting the scaled second message combination to the first neighboring node and the second neighboring node at a symmetric rate.

These and other aspects and advantages of one or more embodiments will become apparent from the following detailed description, which, when taken in conjunction with the drawings, illustrate by way of example the principles of one or more embodiments.

### BRIEF DESCRIPTION OF THE DRAWINGS

For a fuller understanding of the nature and advantages of one or more embodiments, as well as a preferred mode of use, reference should be made to the following detailed description read in conjunction with the accompanying drawings, in which:

FIG. 1 illustrates an example two-way multi-relay network, in accordance with an embodiment of the invention.

FIG. 2 illustrates a block diagram of a two-way multi-relay network, in accordance with an embodiment of the invention.

FIG. 3 illustrates a block diagram of an example two-way two-relay channel network, in accordance with an embodiment of the invention.

FIG. 4 illustrates an example lattice coding system for integrating two half-duplex two-way single-relay channels, in accordance with an embodiment of the invention.

FIG. 5 illustrates an example lattice coding system for integrating two full-duplex two-way single-relay channels, in accordance with an embodiment of the invention.

FIG. 6 illustrates a block diagram of an example terminal node, in accordance with an embodiment of the invention.

FIG. 7 illustrates a block diagram of an example relay node, in accordance with an embodiment of the invention.

FIG. 8 illustrates an example flow chart for re-encoding a decoded message in a relay node using a redistribution transform, in accordance with an embodiment.

FIG. 9 is a high-level block diagram showing an information processing system comprising a computing system implementing an embodiment.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One embodiment provides a method for a relay node. The method comprises receiving a first message combination comprising at least one encoded message from a first neighboring node and at least one encoded message from a second neighboring node. The first message combination is decoded based on one or more decoding constraints. Each decoding constraint is based on a transmission power of a neighboring node. A transform is applied to the decoded first message combination to generate a second message combination for broadcast. The second message combination is scaled based on a transmission power of the relay node and a transmission power of a neighboring node. The scaled second message combination is simultaneously broadcast to the first neighboring node and the second neighboring node at a symmetric rate.

In one embodiment, the relay node simultaneously broadcasts the scaled second message combination to the first neighboring node and the second neighboring node at the same transmission rate, thereby efficiently utilizing the transmission power of the relay node.

In one embodiment, each encoded message from each neighboring node comprises a lattice codeword encoded by the neighboring node. Each lattice codeword is encoded based on a pair of nested lattices.

In one embodiment, the transform applied to the decoded first message combination comprises multiplying the decoded first message combination by an integer value, and applying a modulo operation over a scaled lattice to the decoded first message combination. The scaled lattice comprises a lattice scaled based on a transmission power of a neighboring node.

In one embodiment, each decoding constraint restricts a decoding rate of the relay node based on a transmission power of a neighboring node and a noise variance value. The first message combination is decoded by applying a modulo operation over a scaled lattice to the first message combination, and decoding the first message combination based on one or more decoding constraints to remove noise from the first message combination. The scaled lattice comprises a lattice scaled based on a transmission power of a neighboring node.

In one embodiment, the second message combination is scaled based on a ratio of the transmission power of the relay node to a transmission power of a neighboring node.

Another embodiment provides a system comprising a first terminal node and a second terminal node, wherein the terminal nodes are non-neighboring nodes. The system further comprises at least one relay node interconnecting the terminal nodes. Each relay node is configured for decoding a first message combination comprising encoded messages from neighboring nodes based on one or more decoding constraints, applying a transform to the decoded first message combination to generate a second message combination for broadcast, scaling the second message combination based on a transmission power of the relay node and a transmission power of a neighboring node, and simultaneously broadcasting the scaled second message combination to each neighboring node at a symmetric rate. Each decoding constraint is based on a transmission power of a neighboring node.

Another embodiment provides a data relaying apparatus comprising a decoding module configured for decoding a first message combination based on one or more decoding constraints. The first message combination comprises at least one encoded message from a first neighboring node and at least one encoded message from a second neighboring node. The relaying apparatus further comprises a transform module configured for applying a transform to the decoded first message combination to generate a second message combination for broadcast. The relaying apparatus further comprises a scaling module configured for scaling the second message combination based on a transmission power of the relay node and a transmission power of a neighboring node. The scaled second message combination is simultaneously broadcast to the first neighboring node and the second neighboring node at a symmetric rate. Each decoding constraint is based on a transmission power of a neighboring node.

Another embodiment provides a non-transitory computer-readable medium having instructions which when executed on a computer perform a method for a relay node. The method comprises receiving a first message combination comprising at least one encoded message from a first neighboring node and at least one encoded message from a second neighboring node, and decoding the first message combination based on one or more decoding constraints. Each decoding constraint is based on a transmission power of a neighboring node. The method further comprises applying a transform to the decoded first message combination to generate a second message combination for broadcast, scaling the second message combination based on a transmission power of the relay node and a transmission power of a neighboring node, and simultaneously broadcasting the scaled second message combination to the first neighboring node and the second neighboring node at a symmetric rate.

A lattice codeword is a linear code in Euclidean space. A sum of two lattice codewords is itself a lattice codeword. Lattice coding techniques may be used in multi-source relay networks, such as a two-way two-relay channel. Embodiments provide a lattice coding system for a two-way two-relay channel system. The lattice coding system of one embodiment enables a relay node to remove noise (e.g., Gaussian noise) while decoding a combination of lattice codewords representing multiple messages (i.e., signals). The relay node applies a redistribution transform to the decoded combination to re-encode the decoded combination into a new combination of lattice codewords for broadcast. The redistribution transform applied ensures that messages traveling in either direction fully realize the transmitting power (transmission power) of the relay node even under asymmetric channel conditions.

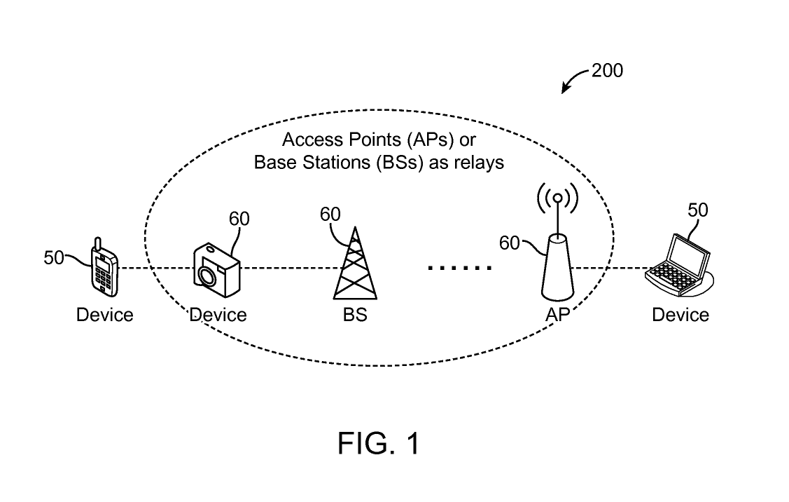

FIG. 1 illustrates an example two-way multi-relay network 200, in accordance with an embodiment of the invention. The network 200 comprises two terminal nodes (i.e., source nodes) 50 and at least one relay node (a data relaying apparatus) 60. Each terminal node 50 may represent a device, such as a server or a user device like a computer, a laptop, a mobile phone, etc. The two terminal nodes 50 communicate with each other via the relay nodes 60. As shown in FIG. 1, a relay node 60 may be an access point (AP), a base station (BS) or a device.

The network 200 operates in two phases: (1) a Multiple-Access Channel (MAC) phase, and (2) a Broadcast Channel (BC) phase. In the MAC phase, each terminal node 50 transmits (i.e., sends) a message to a neighboring relay node 60. Each relay node 60 receives a message combination that includes messages received from neighboring nodes. In the BC phase, each relay node 60 broadcasts the messages received to a neighboring node.

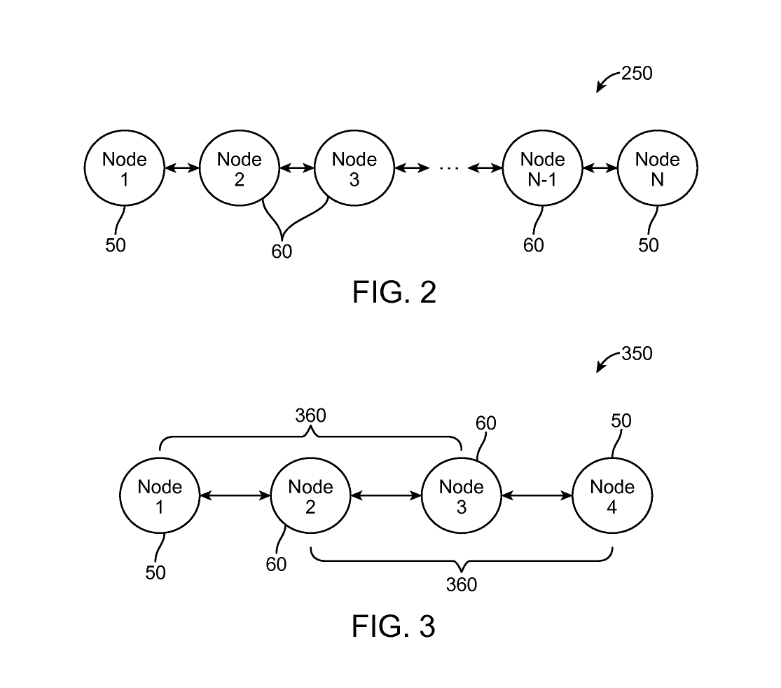

FIG. 2 illustrates a block diagram of a two-way multi-relay network 250, in accordance with an embodiment of the invention. The network 250 comprises two terminal nodes 50 and multiple relay nodes 60. The two terminal nodes 50 communicate with each other via the relay nodes 60. The two terminal nodes 50 are identified in FIG. 2 as Node 1 and Node N. The relay nodes 60 are identified in FIG. 2 as Node 2, Node 3, . . . , and Node N−1.

Each node may only communicate directly with a neighboring node. For example, as shown in FIG. 2, terminal node Node 1 may only communicate directly with relay node Node 2. As another example, relay node Node 2 may only communicate directly with terminal node Node 1 and relay node Node 3.

Let Yᵢ denote a signal received by Node i. Let Xᵢ denote a signal transmitted by Node i. Let Pᵢ denote a transmitting power (transmission power) of Node i. A transmitting power Pᵢ of Node i may be constrained by equation (1) provided below:

E[Xᵢ²]≦Pᵢ (1).

Let Zᵢ represent noise (e.g., white Gaussian noise) with corresponding variance Nᵢ. A signal received by terminal node Node 1 may be represented by equation (2) provided below:

Y₁=X₂+Z₁ (2).

A signal received by terminal node Node N may be represented by equation (3) provided below:

Y_{N}=X_{N-1}+Z_{N} (3).

A signal received by relay node Node i may be represented by equation (4) provided below:

YᵢXᵢ₋₁+Xᵢ₊₁+Zᵢ (4),

wherein i=[2, 3, . . . , N−1] (i.e., Node i is a relay node 60).

FIG. 3 illustrates a block diagram of an example two-way two-relay channel network 350, in accordance with an embodiment of the invention. The network 350 comprises two terminal nodes 50 and two relay nodes 60. As shown in FIG. 3, the two terminal nodes 50 are identified as Node 1 and Node 4, and the two relay nodes 60 are identified as Node 2 and Node 3. Terminal node Node 1 and relay node Node 3 are interconnected via relay node Node 2, and relay node Node 2 and terminal node Node 4 are interconnected via relay node Node 3.

Based on equations (2)-(4) provided above, a signal Y₁ received by terminal node Node 1 is equal to a sum of X₂ and Z₁, a signal Y₂ received by relay node Node 2 is equal to a sum of X₁, X₃ and Z₂, a signal Y₃ received by relay node Node 3 is equal to a sum of X₂, X₄ and Z₃, and a signal Y₄ received by terminal node Node 4 is equal to a sum of X₃ and Z₄.

The network 350 may be divided into two two-way single-relay channels 360 to facilitate lattice coding. For example, the system 350 may be divided into a first two-way single-relay channel 360 that includes terminal node Node 1, relay node Node 2 and relay node Node 3, and a second two-way single-relay channel 360 that includes relay node Node 2, relay node Node 3 and terminal node Node 4. As described in detail later herein, the first and the second two-way single-relay channels 360 are integrated so that both two-way single-relay channels 360 can operate simultaneously.

Assume all channel gains in a two-way single relay channel 360 are 1, and the transmitting power P₁ of Node 1 is greater than the transmitting power P₃ of Node 3 (i.e., P₁>P₃). In the MAC phase, relay node Node 2 decodes a lattice codeword combination (t₁+t₃) mod Λ₁, wherein Λ₁ is a lattice associated with the transmitting power P₁, wherein t₁ represents a lattice codeword from terminal node Node 1, and wherein t₃ represents a lattice codeword from terminal node Node 3. The lattice codeword t₁ is distributed over the entire space V(Λ₁). By comparison, t₃ is only concentrated in V(Λ₂), wherein V(Λ₂) is in the middle of V(Λ₁). To satisfy one or more constraints on the transmitting power P₂ of relay node Node 2, the relay node Node 2 scales the lattice codeword combination (t₁+t₃) mod Λ₁ by ratio √P₂/√P₁, and broadcasts the scaled lattice codeword combination. The transmitting power P₂ of relay node Node 2 in a first direction towards terminal node Node 1 and a second direction towards relay node Node 3 is P₂ and P₂*(P₃/P₁), respectively.

In order to utilize the transmitting power P₂ of relay node Node 2 more efficiently in both directions, the lattice codeword combination (t₁+t₃) mod Λ₁ must be re-distributed such that both t₁ and t₃ are distributed over the entire space of V(Λ₁). Embodiments provide a lattice coding system in the BC phase.

In one embodiment, a redistribution transform is applied to the lattice codeword combination (t₁+t₃) mod Λ₁ to ensure that both t₁ and t₃ are distributed over the entire space of V(Λ₁). Assume that the transmitting power P₃ of relay node Node 3 is multiple times that of the transmitting power P₁ of Node 1. For example, if P₁=p, then P₃=Np, wherein p is a real value, and wherein N is an integer value. Both terminal node Node 1 and relay node Node 3 transmit lattice codewords t₁ mod pA and t₃ mod NpΛ, respectively, to relay node Node 2. Relay node Node 2 receives and decodes a lattice codeword combination (t₁+t₃) mod NpΛ. Relay node Node 2 applies a redistribution transform to the lattice codeword combination (t₁+t₃) mod NpΛ to generate another lattice codeword combination. The redistribution transform comprises multiplying the lattice codeword combination (t₁+t₃) mod NpΛ by N, and performing a modulo operation over NpΛ to generate the lattice codeword combination represented by equation (5) provided below:

(N*(t₁+t₃)mod NpΛ)mod NpΛ)=(Nt₁+Nt₃)mod NpΛ (5).

To satisfy one or more constraints on the transmitting power P₂ of relay node Node 2, relay node Node 2 scales the lattice codeword combination provided by equation (5) by ratio √/P₂/√P₃, and simultaneously broadcasts the scaled lattice codeword combination (√/P₂/√/P₃)*(Nt₁+Nt₃) mod NpΛ to terminal node Node 1 and relay node Node 3. Using one-to-one mappings Nt₁ mod NpΛ<->t₁ mod NpΛ and Nt₃ mod NpΛ<->t₃ mod NpΛ, terminal node Node 1 determines t₃ based on t₁, and relay node Node 3 determines t₁ based on t₃. Both Nt₁ mod NpΛ and Nt₃ mod NpΛ are distributed over the entire space of V(NpΛ), thereby enabling the transmitting power P₂ of relay node Node 2 to be used efficiently in both directions.

For example, assume terminal node Node 1 and relay node Node 3 send lattice codewords t₁ and t₃, respectively, to Node 2 simultaneously, wherein t₁ε{0, 1, 2, 3, 4}, and wherein t₃ε{0,1/2, 1, 3/2, 2}. Relay node Node 2 decodes the lattice codeword combination (t₁+t₃) mod 5, and broadcasts 2*(t₁+t₃ mod 5) mod 5 (i.e., (2t₁+2t₃) mod 5) to both terminal node Node 1 and relay node Node 3. Using one-to-one mappings 2t₁ mod 5<->t₁ and 2t₃ mod 5<->t₃, terminal node Node 1 determines lattice codeword t₃ based on lattice codeword t₁, and relay node Node 3 determines lattice codeword t₁ based on lattice codeword t₃. Both 2t₁ mod 5 and 2t₃ mod 5 are distributed over the entire space of finite field 5, thereby enabling the transmitting power P₂ of relay node Node 2 to be used efficiently in both directions.

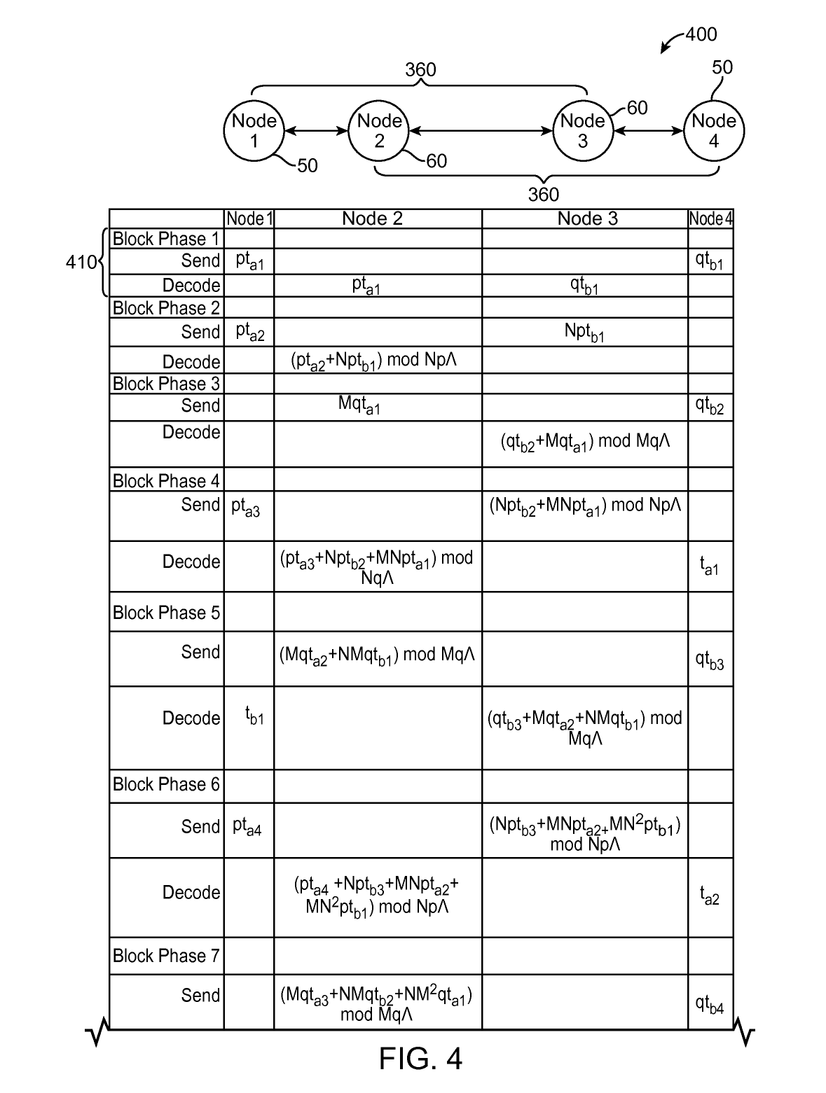

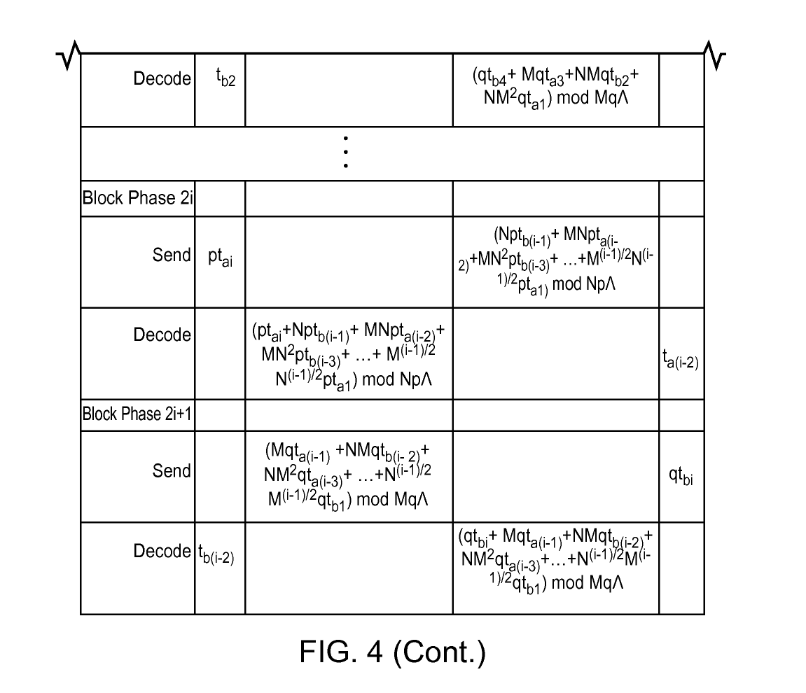

FIG. 4 illustrates an example lattice coding system 400 for integrating two half-duplex two-way single-relay channels 360, in accordance with an embodiment of the invention. In one embodiment, the two-way multi-relay channel 350 in FIG. 3 may be realized by integrating two two-way single-relay channels 360 that are half-duplex.

For example, as shown in FIG. 4, a first two-way single-relay channel 360 includes terminal node Node 1, relay node Node 2, and relay node Node 3. A second two-way single-relay channel 360 includes relay node Node 2, relay node Node 3 and terminal node Node 4. Each two-way single-relay channel 360 in FIG. 4 is a half-duplex communication system that allows for data transmission in both directions but only one direction at a time (i.e., not simultaneously). Each node can only transmit or receive at one time.

Let P denote a large prime number represented by equation (6) provided below:

P=[2^{nR}] (6),

wherein R is a lattice coding rate, and wherein [ ] denotes rounding to the nearest prime number.

Let wₐ and w_{b} generally denote a message generated by terminal node Node 1 and terminal node Node 4, respectively, wherein wₐ, w_{b} ε{0, 1, 2, . . . , P−1}. Each message wₐ, w_{b} is encoded as lattice codeword before transmission.

In one embodiment, each message wₐ, w_{b} is encoded into a lattice codeword based on a nested lattice pair Λ_{c}⊃ Λ, wherein Λ is a coarse lattice, wherein Λ_{c} is a fine lattice, and wherein a second moment of Λ is equal to 1 (i.e., σ²(Λ)=1). Let tₐ and t_{b} generally denote a lattice codeword corresponding to message wₐ and w_{b}, respectively, wherein tₐ, t_{b}ε{Λ_{c}∩V(Λ)}, wherein wₐ [symbol] tₒ represents a one-to-one mapping between message wₐ and lattice codeword tₐ and wherein w_{b} [symbol] t_{b} represents a one-to-one mapping between message w_{b} and lattice codeword t_{b}.

Let Pᵢ denote a transmitting power of Node i. The transmitting power P₁ of terminal node Node 1 is represented by equation (7) provided below:

P₁=p² (7),

wherein p is a real value. The transmitting power P₄ of terminal node Node 4 is represented by equation (8) provided below:

P₄=q² (8),

wherein q is a real value. The transmitting power P₂ of relay node Node 2 is represented by equation (9) provided below:

P₂=M²q² (9),

wherein M is an integer, and wherein M≠P. The transmitting power P₃ of relay node Node 3 is represented by equation (10) provided below:

P₃=N²p2 (10),

wherein N is an integer, and wherein N≠P.

The transmitting power P₁, P₂, P₃ and P₄ may need to satisfy one or more constraints. For example, in one embodiment, ratios P₃/P₁ and P₂/P₄ must be integers' square or reciprocals of integers' square. In another embodiment, ratios P₁/P₃ and P₄/P₂ must be integers' square or reciprocals of integers' square.

As a result of constraints on the transmitting power P₁ of Node 1, Node 1 transmits lattice codewords generally denoted as ptₐ wherein ptₐε{pΛ_{c}∩V(pΛ)}, and wherein ptₐ corresponds to message wₐ. Similarly, as a result of constraints on the transmitting power P₄ of Node 4, Node 4 transmits lattice codewords generally denoted as qt_{b}, wherein qt_{b}ε{qΛ_{c}∩V(qΛ)}, and wherein qt_{b} corresponds to message w_{b}.

As shown in FIG. 4, the lattice coding system 400 includes multiple block phases 410, such as Block Phase 1, Block Phase 2, etc. During each block phase 410, at least one terminal node 50 generates a new message and transmits (i.e., sends) the message as a lattice codeword to a neighboring relay node 60.

Specifically, in Block Phase 1, terminal node Node 1 transmits lattice codeword ptₐ₁ to neighboring relay node Node 2. Terminal node Node 4 transmits lattice codeword qt_{b1} to neighboring relay node Node 3. Relay nodes Node 2 and Node 3 have nothing to broadcast in Block Phase 1.

In Block Phase 1, relay node Node 2 decodes the lattice codewords ptₐ₁ received from terminal node Node 1. Relay node Node 3 decodes the lattice codewords qt_{b1} received from terminal node Node 4. Terminal nodes Node 1 and Node 4 have nothing to decode in Block Phase 1.

In Block Phase 1, each relay node 60 decodes based on transmitting power rate constraints (decoding constraints) represented by equation (11) provided below:

R<½ log(P₁/N₂),R<½ log(P₄/N₃) (11),

wherein N₂ and N₃ are variances associated with noise.

Therefore, in Block Phase 1, there are two point-to-point channels (i.e., a first point-to-point channel between terminal node Node 1 and relay node Node 2, and a second point-to-point channel between relay node Node 3 and terminal node Node 4).

In Block Phase 2, terminal node Node 1 transmits lattice codeword ptₐ₂ to neighboring relay node Node 2. Relay node Node 3 broadcasts lattice codeword Npt_{b2}, wherein the lattice codeword Npt_{b2} represents a scaled version of the lattice codeword qt_{b2} that relay node Node 3 received in Block Phase 1. Relay node Node 3 scales the lattice codeword qt_{b2} based on its transmitting power P₃ provided by equation (10) above. Relay node Node 2 and terminal node Node 4 have nothing to broadcast/transmit in Block Phase 2.

In Block Phase 2, relay node Node 2 receives a lattice codeword combination Y_{2,2} represented by equation (12) provided below:

Y_{2,2}=ptₐ₂+Npt_{b1}+Z_{2,2} (12),

wherein Z_{2,2} represents noise (e.g., white Gaussian noise). To decode the lattice codeword combination Y_{2,2}, relay node Node 2 performs a modulo operation represented by equation (13) provided below:

Y₂₂ mod NpΛ=(ptₐ₂+Npt_{b1}+Z₂₂)mod NpΛ (13).

Relay node Node 2 may then use lattice decoding to decode (ptₐ₂+Npt_{b1}) mod NpΛ from (ptₐ₂+Npt_{b1}+Z₂₂) mod NpΛ. Terminal node Node 1, terminal node Node 4, and relay node Node 3 have nothing to decode in Block Phase 2.

In Block Phase 2, relay node Node 2 decodes based on transmitting power rate constraints represented by equation (14) provided below:

R<½ log(P₁/N₂),R<½ log(P₃/N₂) (14).

In Block Phase 3, terminal node Node 4 transmits lattice codeword qt_{b2} to neighboring relay node Node 3. Relay node Node 2 broadcasts lattice codeword Mqtₐ₁, wherein the lattice codeword Mqtₐ₁ represents a scaled version of the lattice codeword ptₐ₁ that relay node Node 2 received in Block Phase 1. Relay node Node 2 scales the lattice codeword ptₐ₁ based on its transmitting power P₂ provided by equation (9) above. Relay node Node 3 and terminal node Node 1 have nothing to broadcast/transmit in Block Phase 3.

In Block Phase 3, relay node Node 3 receives a lattice codeword combination Y_{3,2} represented by equation (15) provided below:

Y_{3,2}=qt_{b2}+Mqtₐ₁+Z_{3,2} (15),

wherein Z_{3,2} represents noise (e.g., white Gaussian noise). To decode the lattice codeword combination Y_{3,2}, relay node Node 3 performs a modulo operation represented by equation (16) provided below:

Y₃₃ mod MqΛ=(qt_{b2}+Mqtₐ₁+Z_{3,2})mod MqΛ (16).

Relay node Node 3 may then use lattice decoding to decode (qt_{b2}+Mqtₐ₁) mod MqΛ from (qt_{b2}+Mqtₐ₁+Z_{3,2}) mod MqΛ. Terminal node Node 1, terminal node Node 4, and relay node Node 2 have nothing to decode in Block Phase 3.

In Block Phase 3, relay node Node 3 decodes based on transmitting power rate constraints represented by equation (17) provided below:

R<½ log(P₂/N₃),R<½ log(P₄/N₃) (17).

In Block Phase 4, terminal node Node 1 transmits lattice codeword ptₐ₃ to neighboring relay node Node 2. Relay node Node 3 applies a redistribution transform on the decoded lattice codeword combination (qt_{b2}+Mqtₐ₁)mod MqΛ to generate a new lattice codeword combination. Specifically, relay node Node 3 multiplies the decoded lattice codeword combination (qt_{b2}+Mqtₐ₁) mod MqΛ by M, and performs a modulo operation to generate a new lattice codeword combination represented by equation (18) provided below:

$$( {M}^{*} ( {qt}_{b 2} + {Mqt}_{a 1} ) mod Mq Λ ) mod Mq Λ = ( {Mqt}_{b 2} + {M}^{2} {qt}_{a 1} ) mod {M}^{2} q Λ mod Mq Λ = ( {Mqt}_{b 2} + {M}^{2} {qt}_{a 1} ) mod Mq Λ . \qquad ( 18 )$$

Relay node Node 3 scales the lattice codeword combination (Mqt_{b2}+M²qtₐ₁) mod MqΛ by Np/Mq, and broadcasts, in Block Phase 4, the resulting scaled lattice codeword combination represented by equation (19) provided below:

(Np/Mq)*(Mqt_{b2}+M²qtₐ₁)mod MqΛ=(Npt_{b2}+MNptₐ₁)mod NpΛ (19).

Relay node Node 2 and terminal node Node 4 have nothing to broadcast/transmit in Block Phase 4.

In Block Phase 4, relay node Node 2 receives a lattice codeword combination Y_{2,3} represented by equation (20) provided below:

Y_{2,3}=ptₐ3+(Npt_{b2}+MNptₐ₁)mod NpΛ+Z_{2,3} (20),

wherein Z_{2,3} represents noise (e.g., white Gaussian noise). To decode the lattice codeword combination Y_{2,3}, relay node Node 2 performs a modulo operation represented by equation (21) provided below:

$${Y}_{2 , 3} mod Np Λ = ( {pt}_{a 3} + ( {Npt}_{b 2} + {MNpt}_{a 1} ) mod Np Λ + {Z}_{23} ) mod Np Λ = ( {pt}_{a 3} + {Npt}_{b 2} + {MNpt}_{a 1} + {Z}_{23} ) mod Np Λ . \qquad ( 21 )$$

Relay node Node 2 may then use lattice decoding to decode (ptₐ3+Npt_{b2}+MNptₐ₁) mod NpΛ from (ptₐ₃+Npt_{b2}+MNptₐ₁+Z₂₃) mod NpΛ.

In Block Phase 4, terminal node Node 4 receives the lattice codeword combination (Npt_{b2}+MNptₐ₁) mod NpΛ. The terminal node Node 4 decodes the lattice codeword combination (Npt_{b2}+MNptₐ₁) mod NpΛ, and maps the decoded lattice codeword combination to N [symbol] w_{b2}⊕M [symbol] N [symbol] wₐ₁, wherein [symbol] and ⊕ denote addition and multiplication over the finite field P. Using message w_{b2} generated by terminal node Node 4, terminal node Node 4 performs an operation represented by equation (22) provided below:

N [symbol] w_{b}⊕M [symbol] N [symbol] wₐ₁⊖N [symbol] w_{b2}=M [symbol] N [symbol] wₐ₁ (22),

wherein ⊖ denote subtraction over the finite field P. Terminal node Node 4 uses M [symbol] N [symbol] wₐ₁ to determine message wₐ₁ generated by terminal node Node 1. Terminal node Node 1 and relay node Node 3 have nothing to decode in Block Phase 4.

In Block Phase 4, relay node Node 2 decodes based on transmitting power rate constraints represented by equation (14) above. Relay node Node 4 decodes based on transmitting power rate constraints represented by equation (23) provided below:

R<½ log(P₃/N₄) (23),

wherein N₄ is a variance associated with noise.

In Block Phase 5, terminal node Node 4 transmits lattice codeword qt_{b3} to neighboring relay node Node 3. Relay node Node 2 applies a redistribution transform on the decoded lattice codeword combination (ptₐ₂+Npt_{b1}) mod NpΛ to generate a new lattice codeword combination. Specifically, relay node Node 2 multiplies the decoded lattice codeword combination (ptₐ₂+Npt_{b1})mod NpΛ by N and performs a modulo operation to generate a new lattice codeword combination represented by equation (24) provided below:

$$( {N}^{*} ( {p t}_{a 2} + {Npt}_{b 1} ) mod Np Λ ) mod Np Λ = ( {Npt}_{a 2} + {N}^{2} {p t}_{b 1} ) mod {N}^{2} p Λ mod Np Λ = ( {Npt}_{a 2} + {N}^{2} {p t}_{b 1} ) mod Np Λ . \qquad ( 24 )$$

Relay Node 2 scales the lattice codeword combination (Nptₐ2+N²pt_{b1}) mod NpΛ by Mq/Np, and broadcasts, in Block Phase 5, the resulting scaled lattice codeword combination represented by equation (25) provided below:

(Mq/Np)*(Nptₐ₂+N²pt_{b1})mod NpΛ=(Mqtₐ₂+NMqt_{b1})mod MqΛ (25).

Relay node Node 3 and terminal node Node 1 have nothing to broadcast/transmit in Block Phase 5.

In Block Phase 5, relay node Node 3 receives a lattice codeword combination Y_{3,3} represented by equation (26) provided below:

Y_{3,3}=qt_{b3}+(Mqtₐ₂+NMqt_{b1})mod MqΛ+Z_{3,3} (26),

wherein Z_{3,3} represents noise (e.g., Gaussian noise). To decode the lattice codeword combination Y_{3,3}, relay node Node 3 performs a modulo operation represented by equation (27) provided below:

$${Y}_{3 , 3} mod Mq Λ = ( {q t}_{b 3} + ( {Mqt}_{a 2} + {NMqt}_{b 1} ) mod Mq Λ + {Z}_{3 , 3} ) mod Mq Λ = ( {qt}_{b 3} + {Mqt}_{a 2} + {NMqt}_{b 1} + {Z}_{33} ) mod Mq Λ . \qquad ( 27 )$$

Relay node Node 3 may then use lattice decoding to decode (qt_{b3}+Mqtₐ2+NMqt_{b1}) mod MqΛ from (qt_{b3}+Mqtₐ2+NMqt_{b1}+Z₃₃) mod MqΛ.

In Block Phase 5, terminal node Node 1 receives the lattice codeword combination (Mqtₐ₂+NMqt_{b1}) mod MqΛ. The terminal node Node 1 decodes the lattice codeword combination (Mqtₐ₂+NMqt_{b1}) mod MqΛ, and maps the decoded lattice codeword combination to M [symbol] wₐ₂⊕N [symbol] M [symbol] w_{b1}, wherein [symbol] and ⊕ denote addition and multiplication over the finite field P. Using message wₐ₂ generated by terminal node Node 1, terminal node Node 1 performs an operation represented by equation (28) provided below:

M [symbol] wₐ₂⊕N [symbol] M [symbol] w_{b1}⊖M [symbol] wₐ₂=N [symbol] M [symbol] w_{b1} (28),

wherein ⊖ denote subtraction over the finite field P. Terminal node Node 4 uses N [symbol] M [symbol] w_{b1} to determine message w_{b1} generated by terminal node Node 4. Terminal node Node 4 and relay node Node 2 have nothing to decode in Block Phase 5.

In Block Phase 5, relay node Node 3 decodes based on transmitting power rate constraints represented by equation (17) above. Terminal node Node 1 decodes based on transmitting power rate constraints represented by equation (29) provided below:

R<½ log(P₂/N₁) (29),

wherein N₁ is a variance associated with noise.

Let i represent an odd number. In Block Phase 2i, terminal node Node 1 transmits lattice codeword ptₐᵢ to neighboring relay node Node 2. Relay node Node 3 applies a redistribution transform on a decoded lattice codeword combination to generate a new lattice codeword combination, scales the new lattice codeword combination by Np/Mq, and broadcasts, in Block Phase 2i, the resulting scaled lattice codeword combination represented by equation (30) provided below:

$$( {Npt}_{b ( i - 1 )} + {MNpt}_{a ( i - 2 )} + {MN}^{2} {pt}_{b ( i - 3 )} + … + {M}^{( i - 1 ) / 2} {N}^{( i - 1 ) / 2} {pt}_{a 1} ) mod Np Λ . \qquad ( 30 )$$

Relay node Node 2 and terminal node Node 4 have nothing to broadcast/transmit in Block Phase 2i.

In Block Phase 2i, relay node Node 2 receives a lattice codeword combination Y_{2,i} represented by equation (31) provided below:

$${Y}_{2 , i} = {pt}_{ai} + ( {Npt}_{b ( i - 1 )} + {MNpt}_{a ( i - 2 )} + {MN}^{2} {pt}_{b ( i - 3 )} + … + {M}^{( i - 1 ) / 2} {N}^{( i - 1 ) / 2} {pt}_{a 1} ) mod Np Λ + {Z}_{2 , i} , \qquad ( 31 )$$

wherein Z_{2,i} represents noise (e.g., Gaussian noise). To decode the lattice codeword combination Y_{2,i}, relay node Node 2 performs a modulo operation represented by equation (32) provided below:

$${Y}_{2 , i} mod Np Λ = ( {pt}_{ai} + ( {Npt}_{b ( i - 1 )} + {MNpt}_{a ( i - 2 )} + {MN}^{2} {pt}_{b ( i - 3 )} + … + {M}^{( i - 1 ) / 2} {N}^{( i - 1 ) / 2} {pt}_{a 1} ) mod Np Λ + {Z}_{2 , i} ) mod Np Λ = ( {pt}_{ai} + {Npt}_{b ( i - 1 )} + {MNpt}_{a ( i - 2 )} + {MN}^{2} {pt}_{b ( i - 3 )} + … + {M}^{( i - 1 ) / 2} {N}^{( i - 1 ) / 2} {pt}_{a 1} + {Z}_{2 , i} ) mod Np Λ . \qquad ( 32 )$$

Relay node Node 2 may then use lattice decoding to decode (ptₐᵢ+Npt_{b(i-2) MNpt}ₐ₍ᵢ₋₂₎+MN²pt_{b(i-3)}+ . . . +M^{(i-1)/2}N^{(i-1)/2}ptₐ₁) mod NpΛ from (ptₐᵢ+(Npt_{b(i-1)}+MNptₐ₍ᵢ₋₂₎+MN²pt_{b(i-3)}++M^{(i-1)/2}N^{(i-1)/2}ptₐ₁+Z_{2,i}) mod NpΛ. Relay node Node 2 will apply a redistribution transform on the decoded lattice codeword combination (ptₐᵢ+Npt_{b(i-1)}+MNptₐ₍ᵢ₋₂₎+MN²pt_{b(i-3)}++M^{(i-1)/2}N^{(i-1)/2} ptₐ₁) mod NpΛ to generate a new lattice codeword combination. Specifically, relay node Node 2 multiplies the decoded lattice codeword combination (ptₐᵢ+Npt_{b(i-1)}+MNptₐ₍ᵢ₋₂₎+MN²pt_{b(i-3)}+ . . . +M_{(i-1)/2}N^{(i-1)/2}ptₐ₁) mod NpΛ by N, and performs a modulo operation to generate a new lattice codeword combination represented by equation (33) provided below:

$$( N * ( {pt}_{ai} + {Npt}_{b ( i - 1 )} + {MNpt}_{a ( i - 2 )} + {MN}^{2} {pt}_{b ( i - 3 )} + … + {M}^{( i - 1 ) / 2} {N}^{( i - 1 ) / 2} {pt}_{a 1} ) mod Np Λ ) mod Np Λ = ( {Npt}_{ai} + {N}^{2} {pt}_{b ( i - 1 )} + {MN}^{2} {pt}_{a ( i - 2 )} + {MN}^{3} {pt}_{b ( i - 3 )} + … + {M}^{( i - 1 ) / 2} {N}^{( ( i - 1 ) / 2 ) + 1} {pt}_{a 1} ) mod Np Λ . \qquad ( 33 )$$

Relay node Node 2 scales the lattice codeword combination (NPtₐᵢ+N²pt_{b(i-1)}+MN²ptₐ₍ᵢ₋₂₎+MN³pt_{b(i-3)}+ . . . +M^{(i-1)/2}N^{((i-1)/2)+1}ptₐ₁) mod NpΛ by Mq/Np, and broadcasts, in Block Phase 2i+2, the resulting scaled lattice codeword combination represented by equation (34) provided below:

$$( Mq / Np ) * ( {Npt}_{ai} + {N}^{2} {pt}_{b ( i - 1 )} + {MN}^{2} {pt}_{a ( i - 2 )} + {MN}^{3} {pt}_{b ( i - 3 )} + … + {M}^{( i - 1 ) / 2} {N}^{( ( i - 1 ) / 2 ) + 1} {pt}_{a 1} ) mod Np Λ = ( {Mqt}_{ai} + {NMqt}_{b ( i - 1 )} + {NM}^{2} {qt}_{a ( i - 2 )} + {N}^{2} {M}^{2} {qt}_{b ( i - 3 )} + … + {N}^{( i - 1 ) / 2} {M}^{( ( i - 1 ) / 2 ) + 1} {pt}_{a 1} ) mod Np Λ . \qquad ( 34 )$$

In Block Phase 2i, terminal node Node 4 receives the lattice codeword combination (Npt_{b(i-1)}+MNptₐ₍ᵢ₋₂₎+MN²pt_{b(i-3)}+ . . . +M^{(i-1)/2}N^{(i-1)/2}ptₐ₁) mod NpΛ from relay node Node 3. The terminal node Node 4 decodes the lattice codeword combination

$$( {Npt}_{b ( i - 1 )} + {MNpt}_{a ( i - 2 )} + {MN}^{2} {pt}_{b ( i - 3 )} + … + {M}^{( i - 1 ) / 2} {N}^{( i - 1 ) / 2} {pt}_{a 1} ) mod Np Λ to N ⊗ {w}_{b ( i - 1 )} ⊕ M ⊗ N ⊗ {w}_{a ( i - 2 )} + M ⊗ {N}^{2} ⊗ {w}_{b ( i - 3 )} + … + {M}^{( i - 1 ) / 2} ⊗ {N}^{( i - 1 ) / 2} ⊗ {w}_{a 1} .$$

Using messages that the terminal node Node 4 generated or decoded in previous block phases 410, terminal node Node 4 obtains M [symbol] N [symbol] wₐ₍ᵢ₋₂₎, and determines message wₐ₍ᵢ₋₂₎ based on M [symbol] N [symbol] wₐ₍ᵢ₋₂₎. Terminal node Node 1 and relay node Node 3 have nothing to decode in Block Phase 4.

In Block Phase 2i, relay node Node 2 decodes based on transmitting power rate constraints represented by equation (14) above. Relay node Node 4 decodes based on transmitting power rate constraints represented by equation (23) above.

In Block Phase 2i+1, terminal node Node 4 transmits lattice codeword qt_{bi} to neighboring relay node Node 3. Relay node Node 2 applies a redistribution transform on a decoded lattice codeword combination to generate a new lattice codeword combination, scales the new lattice codeword combination by Mq/Np, and broadcasts, in Block Phase 2i+1, the resulting scaled lattice codeword combination represented by equation (35) provided below:

(Mqtₐ₍ᵢ₋₁₎+NMqt_{b(i-2)}+NM²qtₐ₍ᵢ₋₃₎+ . . . −N^{(i-1)/2}M⁽ⁱ⁻²⁾/2qt_{b1})mod MqΛ (35).

Relay node Node 3 and terminal node Node 1 have nothing to broadcast/transmit in Block Phase 2i+1.

In Block Phase 2i+1, relay node Node 3 receives a lattice codeword combination Y_{3,i} represented by equation (36) provided below:

$${Y}_{3 , i} = {qt}_{bi} + ( {Mqt}_{a ( i - 1 )} + {NMqt}_{b ( i - 2 )} + {NM}^{2} {qt}_{a ( i - 3 )} + … + {N}^{( i - 1 ) / 2} {M}^{( i - 1 ) / 2} {qt}_{b 1} ) mod Mq Λ + {Z}_{3 , i} , \qquad ( 36 )$$

wherein Z_{3,i} represents noise (e.g., Gaussian noise). To decode the lattice codeword combination Y_{3,i}, relay node Node 3 performs a modulo operation represented by equation (37) provided below:

$${Y}_{3 , i} mod Mq Λ = ( {qt}_{bi} + ( {Mqt}_{a ( i - 1 )} + {NMqt}_{b ( i - 2 )} + {NM}^{2} {qt}_{a ( i - 3 )} + … + {N}^{( i - 1 ) / 2} {M}^{( i - 1 ) / 2} {qt}_{b 1} ) mod Mq Λ + {Z}_{3 , i} ) mod Mq Λ = ( {qt}_{bi} + {Mqt}_{a ( i - 1 )} + {NMqt}_{b ( i - 2 )} + {NM}^{2} {qt}_{a ( i - 3 )} + … + {N}^{( i - 1 ) / 2} {M}^{( i - 1 ) / 2} {qt}_{b 1} + {Z}_{3 , i} ) mod Mq Λ . \qquad ( 37 )$$

Relay node Node 3 may then use lattice decoding to decode

$$( {qt}_{bi} + {Mqt}_{a ( i - 1 )} + {NMqt}_{b ( i - 2 )} + {NM}^{2} {qt}_{a ( i - 3 )} + … + {N}^{( i - 1 ) / 2} {M}^{( i - 1 ) / 2} {qt}_{b 1} ) mod Mq Λ from ( {qt}_{bi} + {Mqt}_{a ( i - 1 )} + {NMqt}_{b ( i - 2 )} + {NM}^{2} {qt}_{a ( i - 3 )} + … + {N}^{( i - 1 ) / 2} {M}^{( i - 1 ) / 2} {qt}_{b 1} + {Z}_{3 , i} ) mod Mq Λ .$$

In Block Phase 2i+1, terminal node Node 1 receives the lattice codeword combination (Mqtₐ₍ᵢ₋₁₎+NMqt_{b(i-2)}+NM²qtₐ₍ᵢ₋₃₎+ . . . +N^{(i-1)/2}M^{(i-1)/2}qt_{b1}) mod MqΛ from relay node Node 2. The terminal node Node 1 decodes the lattice codeword combination (Mqtₐ₍ᵢ₋₁₎+NMqt_{b(i-2)}+NM²qtₐ₍ᵢ₋₃₎+ . . . +N^{(i-1)/2}M^{(i-1)/2}qt_{b1}) mod MqΛ to M [symbol] wₐ₍ᵢ₋₁₎⊕N [symbol] M [symbol] w_{b(i-2}+N [symbol] M² [symbol] wₐ₍ᵢ₋₃₎+ . . . +N^{(i-1)/2} [symbol] M^{(i-1)/2} [symbol] w_{b1} Using the messages that terminal node Node 1 generated or decoded in previous block phases 410, terminal node Node 1 obtains N [symbol] M [symbol] w_{b(i-2)}, and determines message w_{b(i-2)} based on N [symbol] M [symbol] w_{b(i-2)}. Terminal node Node 4 and relay node Node 2 have nothing to decode in Block Phase 2i+1.

In Block Phase 2i+1, relay node Node 3 decodes based on transmitting power rate constraints represented by equation (17) above. Relay node Node 4 decodes based on transmitting power rate constraints represented by equation (23) above.

The transmitting power rate constraints for decoding in the lattice coding system 400 are summarized in equation (38) provided below:

$$R \leq min ( \frac{1}{2} log ( {P}_{1} / {N}_{2} ) , \frac{1}{2} log ( {P}_{2} / {N}_{3} ) , \frac{1}{2} log ( {P}_{3} / {N}_{4} ) , \frac{1}{2} log ( {P}_{4} / {N}_{3} ) , \frac{1}{2} log ( {P}_{3} / {N}_{2} ) , \frac{1}{2} log ( {P}_{2} / {N}_{1} ) ) . \qquad ( 38 )$$

Let R_{FINAL} denote a final achievable symmetric rate for a lattice coding system. The final achievable symmetric rate R_{FINAL} for the lattice coding system 400 is represented by equation (39) provided below:

R_{FINAL}=((2I−2)/(2I+1))*(1/2)*R (39),

wherein 2I+1 denotes the total number of block phases 410 in the system 400. When I approaches infinity, the final achievable symmetric rate R_{FINAL} for the lattice coding system 400 is represented by equation (40) provided below:

R_{FINAL}=(1/2)*R (40).

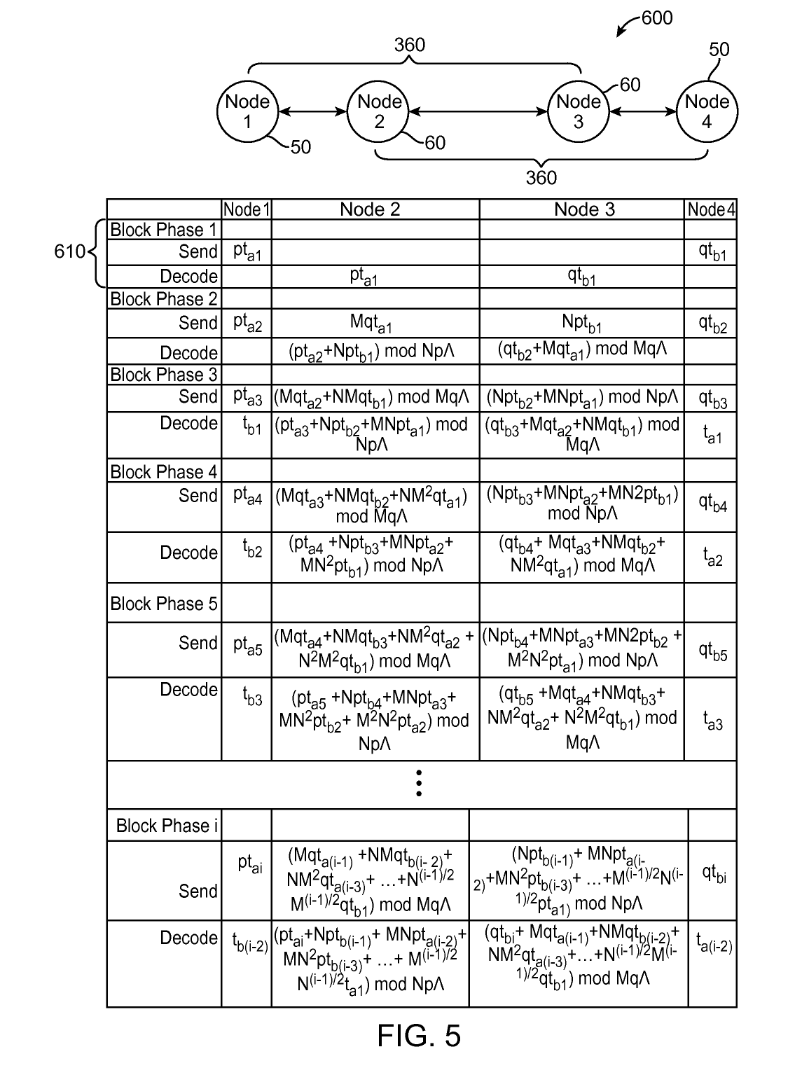

FIG. 5 illustrates an example lattice coding system 500 for integrating two full-duplex two-way single-relay channels 360, in accordance with an embodiment of the invention. In another embodiment, the two-way multi-relay channel 350 in FIG. 4-1 may be realized by integrating two two-way single-relay channels 360 that are full-duplex.

For example, as shown in FIG. 5, a first two-way single-relay channel 360 includes terminal node Node 1, relay node Node 2, and relay node Node 3. A second two-way single-relay channel 360 includes relay node Node 2, relay node Node 3 and terminal node Node 4. Each two-way single-relay channel 360 in FIG. 5 is a full-duplex communication system that allows for data transmission in both directions at the same time (i.e., not simultaneously). Each node can transmit and receive at the same time.

In lattice coding system 600, each message wₐ and w_{b} generated by terminal node Node 1 and terminal node Node 4, respectively, is encoded before transmission. Like in the lattice coding system 400, each message wₐ and each message w_{b} is encoded into a lattice codeword tₐ and a lattice codeword t_{b}, respectively, based on the nested lattice pair Λ_{c}⊃Λ.

The transmitting power P₁ of terminal node Node 1 and the transmitting power P₄ of terminal node Node 4 is represented by equation (7) provided above and equation (8) provided above, respectively. The transmitting power P₂ of relay node Node 2 and the transmitting power P₃ of relay node Node 3 is represented by equation (9) provided above and equation (10) provided above. As a result of constraints on the transmitting power P₁ of terminal node Node 1 and the transmitting power P₄ of terminal node Node 4, terminal node Node 1 and terminal node Node 4 transmit lattice codewords generally denoted as ptₐ and pt_{b}, respectively.

As shown in FIG. 5, the lattice coding system 600 includes multiple block phases 610, such as Block Phase 1, Block Phase 2, etc. During each block phase 610 of the lattice coding system 600, each terminal node 50 generates a new message and transmits (i.e., sends) the message as a lattice codeword to a neighboring relay node 60.

For example, in Block Phase 1 of the lattice coding system 600, terminal node Node 1 transmits lattice codeword ptₐ₁ to neighboring relay node Node 2. Terminal node Node 4 also transmits lattice codeword qt_{b1} to neighboring relay node Node 3. Relay nodes Node 2 and Node 3 have nothing to broadcast (i.e., transmit) in Block Phase 1 of the lattice coding system 600.

Further, in Block Phase 1 of the lattice coding system 600, relay node Node 2 decodes the lattice codeword ptₐ₁ received from terminal node Node 1. Relay node Node 3 also decodes the lattice codeword qt_{b1} received from terminal node Node 4. Terminal nodes Node 1 and Node 4 have nothing to decode in Block Phase 1 of the lattice coding system 600. Each relay node 60 in Block Phase 1 of the lattice coding system 600 decodes based on transmitting power rate constraints represented by equation (11) provided above.

Therefore, like in the lattice coding system 400, there are two point-to-point channels (i.e., a first point-to-point channel between terminal node Node 1 and relay node Node 2, and a second point-to-point channel between relay node Node 3 and terminal node Node 4) in Block Phase 1 of the lattice coding system 600.

In Block Phase 2 of the lattice coding system 600, terminal node Node 1 transmits lattice codeword ptₐ2 to neighboring relay node Node 2. Terminal node Node 4 also transmits lattice codeword qt_{b2} to neighboring relay node Node 3.

Further, in Block Phase 2 of the lattice coding system 600, relay node Node 3 broadcasts lattice codeword Npt_{b1}. Relay node Node 2 also broadcasts lattice codeword Mqtₐ₁. The lattice codeword Npt_{b2} represents a scaled version of the lattice codeword qt_{b2} that relay node Node 3 received from terminal node Node 4 in Block Phase 1 of the lattice coding system 600. Relay node Node 3 scales the lattice codeword qt_{b2} based on its transmitting power P₃ represented by equation (10) provided above. The lattice codeword Mqtₐ₁ represents a scaled version of the lattice codeword ptₐ₁ that relay node Node 2 received from terminal node Node 1 in Block Phase 1 of the lattice coding system 600. Relay node Node 2 scales the lattice codeword ptₐ₁ based on its transmitting power P₂ represented by equation (9) provided above.

Further, in Block Phase 2 of the lattice coding system 600, relay node Node 2 receives and decodes the lattice codeword combination Y_{2,2} represented by equation (12) provided above. Relay node Node 3 also receives and decodes the lattice codeword combination Y_{3,2} represented by equation (15) provided above. Terminal nodes Node 1 and Node 4 have nothing to decode in Block Phase 2 of the lattice coding system 600.

To decode the lattice codeword combination Y_{2,2}, relay node Node 2 performs a modulo operation represented by equation (13) provided above to obtain (ptₐ2+Npt_{b1}+Z₂₂) mod NpΛ. Relay node Node 2 may then use lattice decoding to decode (ptₐ2+Npt_{b1}) mod NpΛ from (ptₐ2+Npt_{b1}+Z₂₂) mod NpΛ. To decode the lattice codeword combination Y_{3,2}, relay node Node 3 performs a modulo operation represented by equation (16) provided above to obtain (qt_{b2}+Mqtₐ₁+Z_{3,2}) mod MqΛ. Relay node Node 3 may then use lattice decoding to decode (qt_{b2}+Mqtₐ₁) mod MqΛ from (qt_{b2}+Mqtₐ₁+Z_{3,2}) mod MqΛ.

In Block Phase 2 of the lattice coding system 600, relay nodes Node 2 and Node 3 decode based on transmitting power rate constraints represented by equation (14) provided above and by equation (17) provided above, respectively.

In Block Phase 3 of the lattice coding system 600, terminal node Node 1 transmits lattice codeword ptₐ3 to neighboring relay node Node 2. Terminal node Node 4 also transmits lattice codeword qt_{b3} to neighboring relay node Node 3.

Further, in Block Phase 3 of the lattice coding system 600, relay node Node 3 broadcasts lattice codeword combination (Npt_{b2}+MNptₐ₁) mod NpΛ. Relay node Node 2 also broadcasts lattice codeword combination (Mqtₐ2+NMqt_{b1}) mod MqΛ.

To generate the lattice codeword combination (Npt_{b2}+MNptₐ₁) mod NpΛ for broadcast, relay node Node 3 applies a redistribution transform on the decoded lattice codeword combination (qt_{b2}+Mqtₐ₁) mod MqΛ, and scales a resulting lattice codeword combination for broadcast. The redistribution transform and scaling operation applied by relay node Node 3 are represented by equations (18) and (19) provided above.

To generate the lattice codeword combination (Mqtₐ₂+NMqt_{b1}) mod MqΛ for broadcast, relay node Node 2 applies a redistribution transform on the decoded lattice codeword combination (ptₐ₂+Npt_{b1}) mod NpΛ, and scales a resulting lattice codeword combination for broadcast. The redistribution transform and scaling operation applied by relay node Node 2 are represented by equations (24) and (25) provided above.

Further, in Block Phase 3 of the lattice coding system 600, relay node Node 2 receives and decodes the lattice codeword combination Y_{2,3} represented by equation (20) provided above. Relay node Node 3 also receives and decodes a lattice codeword combination Y_{3,3} represented by equation (26) provided above.

To decode the lattice codeword combination Y_{2,3}, relay node Node 2 performs a modulo operation represented by equation (21) provided above to obtain (ptₐ3+Npt_{b2}+MNptₐ₁+Z₂₃) mod NpΛ. Relay node Node 2 may then use lattice decoding to decode (ptₐ3+Npt_{b2}+MNptₐ₁) mod NpΛ from (ptₐ₃+Npt_{b2}+MNptₐ₁+Z₂₃) mod NpΛ.

To decode the lattice codeword combination Y_{3,3}, relay node Node 3 performs a modulo operation represented by equation (27) provided above to obtain (qt_{b3}+Mqtₐ2+NMqt_{b1}+Z₃₃) mod MqΛ. Relay node Node 3 may then use lattice decoding to decode (qt_{b3}+Mqtₐ₂+NMqt_{b1}) mod MqΛ from (qt_{b3}+Mqtₐ₂+NMqt_{b1}+Z₃₃) mod MqΛ.

In Block Phase 3 of the lattice coding system 600, relay nodes Node 2 and Node 3 decode based on transmitting power rate constraints represented by equation (14) provided above and by equation (17) provided above, respectively.

Further, in Block Phase 3 of the lattice coding system 600, terminal node Node 4 decodes the lattice codeword combination (Npt_{b2}+MNptₐ₁)mod NpΛ received from relay node Node 3. Terminal node Node 1 also decodes the lattice codeword combination (Mqtₐ₂+NMqt_{b1}) mod MqΛ received from relay node Node 2.

Terminal node Node 4 decodes the lattice codeword combination (Npt_{b2}+MNptₐ₁) mod NpΛ, and maps the decoded lattice codeword combination to N [symbol] w_{b2}⊕M [symbol] N [symbol] wₐ₁. Using message w_{b2} generated by terminal node Node 4, terminal node Node 4 performs an operation represented by equation (22) provided above to obtain M [symbol] N [symbol] wₐ₁. Terminal node Node 4 uses M [symbol] N [symbol] wₐ₁ to determine message wₐ₁ generated by terminal node Node 1.

Terminal node Node 1 decodes the lattice codeword combination (Mqtₐ₂+NMqt_{b1}) mod MqΛ, and maps the decoded lattice codeword combination to M [symbol] wₐ₂⊕N [symbol] M [symbol] w_{b1}. Using message wₐ₂ generated by terminal node Node 1, terminal node Node 1 performs an operation represented by equation (28) provided above to obtain N [symbol] M [symbol] w_{b1}. Terminal node Node 4 uses N [symbol] M [symbol] w_{b1} to determine message w_{b1} generated by terminal node Node 4.

In Block Phase 3 of the lattice coding system 600, terminal nodes Node 1 and Node 4 decode based on transmitting power rate constraints represented by equation (30) provided above and by equation (23) provided above, respectively.

Let i represent an odd number. In Block Phase i of the lattice coding system 600, terminal node Node 1 transmits lattice codeword ptₐᵢ to neighboring relay node Node 2. Terminal node Node 4 also transmits lattice codeword qt_{bi} to neighboring relay node Node 3.

Further, in Block Phase i of the lattice coding system 600, relay node Node 3 broadcasts lattice codeword combination (Npt_{b(i-1)}+MNptₐ₍ᵢ₋₂₎+MN²pt_{b(i-3)}+ . . . +M^{(i-1)/2}N^{(i-1)/2}ptₐ₁) mod NpΛ. Relay node Node 2 also broadcasts lattice codeword combination (Mqtₐ₍ᵢ₋₁₎+NMqt_{b(i-2)}+NM²qtₐ₍ᵢ₋₃₎+ . . . +N^{(i-1)/2}M^{(i-1)/2}qt_{b1}) mod MqΛ.

To generate the lattice codeword combination (Npt_{b(i-1)}+MNptₐ₍ᵢ₋₂₎+MN²pt_{b(i-3)}+ . . . +M^{(i-1)/2}N^{(i-1)/2}ptₐ₁) mod NpΛ for broadcast, relay node Node 3 applies the redistribution transform on a decoded lattice codeword combination, and scales a resulting lattice codeword combination by Np/Mq for broadcast.

To generate the lattice codeword combination (Mqtₐ₍ᵢ₋₁₎+NMqt_{b(i-2)}+NM²qtₐ₍ᵢ₋₃₎+ . . . +N^{(i-1)/2}M^{(i-1)/2}qt_{b1}) mod MqΛ for broadcast, relay node Node 2 applies the redistribution transform on a decoded lattice codeword combination, and scales the resulting lattice codeword combination Mq/Np for broadcast.

Further, in Block Phase i of the lattice coding system 600, relay node Node 2 receives and decodes the lattice codeword combination Y_{2,i} represented by equation (31) provided above. Relay node Node 3 also receives and decodes a lattice codeword combination Y_{3,i} represented by equation (36) provided above.

To decode the lattice codeword combination Y_{2,i}, relay node Node 2 performs a modulo operation represented by equation (32) provided above to obtain (ptₐᵢ+Npt_{b(i-1)}MNptₐ₍ᵢ₋₂₎+MN²pt_{b(i-3)}+ . . . +M^{(i-1)/2}N^{(i-1)/2}ptₐ₁+Z_{2,i}) mod NpΛ. Relay node Node 2 may then use lattice decoding to decode

$$( {p t}_{ai} + {Npt}_{b ( i - 1 )} + {MNpt}_{a ( i - 2 )} + {MN}^{2} {p t}_{b ( i - 3 )} + … + {M}^{( i - 1 ) / 2} {N}^{( i - 1 ) / 2} {p t}_{a 1} ) mod Np Λ from ( {p t}_{ai} + ( {Npt}_{b ( i - 1 )} + {MNpt}_{a ( i - 2 )} + {MN}^{2} {p t}_{b ( i - 3 )} + … + {M}^{( i - 1 ) / 2} {N}^{( i - 1 ) / 2} {p t}_{a 1} + {Z}_{2 , i} ) mod Np Λ .$$

To decode the lattice codeword combination Y_{3,i}, relay node Node 3 performs a modulo operation represented by equation (37) provided above to obtain (qt_{bi}+Mqtₐ₍ᵢ₋₁₎+NMqt_{b(i-2)}+NM²qtₐ₍ᵢ₋₃₎+ . . . +N_{(i-1)/2}M^{(i-1)/2}qt_{b1} Z_{3,i}) mod MqΛ. Relay node Node 3 may then use lattice decoding to decode

$$( {qt}_{bi} + {Mqt}_{a ( i - 1 )} + {NMqt}_{b ( i - 2 )} + {NM}^{2} {qt}_{a ( i - 3 )} + … + {N}^{( i - 1 ) / 2} {M}^{( i - 1 ) / 2} {qt}_{b 1} ) mod Mq Λ from ( {qt}_{bi} + {Mqt}_{a ( i - 1 )} + {NMqt}_{b ( i - 2 )} + {NM}^{2} {qt}_{a ( i - 3 )} + … + {N}^{( i - 1 ) / 2} {M}^{( i - 1 ) / 2} {qt}_{b 1} + {Z}_{3 , i} ) mod Mq Λ .$$

In Block Phase i of the lattice coding system 600, relay nodes Node 2 and Node 3 decode based on transmitting power rate constraints represented by equation (14) provided above and by equation (17) provided above, respectively.

Further, in Block Phase i of the lattice coding system 600, terminal node Node 4 decodes the lattice codeword combination (Npt_{b(i-1)}+MNptₐ₍ᵢ₋₂₎+MN²pt_{b(i-3)}+ . . . +M^{(i-1)/2}N^{(i-1)/2}ptₐ₁) mod NpΛ received from relay node Node 3. Terminal node Node 1 also decodes the lattice codeword combination (Mqtₐ₍ᵢ₋₁₎+NMqt_{b(i-2)}+NM²qtₐ₍ᵢ₋₃₎+ . . . +N^{(i-1)/2}M⁽ⁱ⁻¹)^{/2}qt_{b1}) mod MqΛ received from relay node Node 2.

Terminal node Node 4 decodes the lattice codeword combination (Npt_{b(i-1)}+MNPtₐ₍ᵢ₋₂₎+MN²Pt_{b(i-3)}+ . . . +M^{(i-1)/2}N^{(i-1)/2}ptₐ₁) mod NpΛ, and maps the decoded lattice codeword combination to N [symbol] w_{b(i-1)}⊕M [symbol] N [symbol] wₐ₍ᵢ₋₂₎+M [symbol] N² [symbol] w_{b(i-3)}+ . . . +M^{(i-1)/2} [symbol] N^{(i-1)/2} [symbol] wₐ₁. Using messages that terminal node Node 4 generated or decoded in previous block phases 610, terminal node Node 4 obtains M [symbol] N [symbol] wₐ₍ᵢ₋₂₎, and determines message wₐ₍ᵢ₋₂₎ based on M [symbol] N [symbol] wₐ₍ᵢ₋₂₎.

Terminal node Node 1 decodes the lattice codeword combination (Mqtₐ₍ᵢ₋₁₎+NMqt_{b(i-2)}+NM²qtₐ₍ᵢ₋₃₎+ . . . +N^{(i-1)/2}M^{(i-1)/2}qt_{b1}) mod MqΛ, and maps the decoded lattice codeword combination to M [symbol] wₐ₍ᵢ₋₁₎⊕N [symbol] M [symbol] w_{a(i-2)+N} [symbol] _{M}² [symbol] wₐ₍ᵢ₋₃₎+ . . . +N^{(i-1)/2} [symbol] M^{(i-1)/2} [symbol] w_{b1}. Using messages that terminal node Node 1 generated or decoded in previous block phases 610, terminal node Node 1 obtains N [symbol] M [symbol] w_{b(i-2)}, and determines message w_{b(i-2)} based on N [symbol] M [symbol] w_{b(i-2)}.

In Block Phase i of the lattice coding system 600, terminal nodes Node 1 and Node 4 decode based on transmitting power rate constraints represented by equation (30) provided above and by equation (23) provided above, respectively.

The transmitting power rate constraints for decoding in the lattice coding system 600 are summarized in equation (40) provided above.

The final achievable symmetric rate R_{FINAL} for the lattice coding system 600 is represented by equation (41) provided below:

R_{FINAL}=((I−2)/I)*R (41),

wherein I denotes the total number of block phases 610 in the system 600. When I approaches infinity, the final achievable symmetric rate R_{FINAL} for the lattice coding system 600 is represented by equation (42) provided below:

R_{FINAL}=R (42).

In one embodiment, ratios P₃/P₁ and P₂/P₄ are neither integers' square nor reciprocals of integers' square. The transmitting powers P₁, P₂, P₃ and P₄ may be truncated such that E[X²₃]/E[X²₁] and E [X²₂]/E [X²₄] are integers' square or reciprocals of integers' square. For example, if P₃=3.6 and P₁=1, E[X²₃] and E[X²₁] may be set to 3.6 and 0.9, respectively, such that E[X²₃]/E[X²₁]=2².

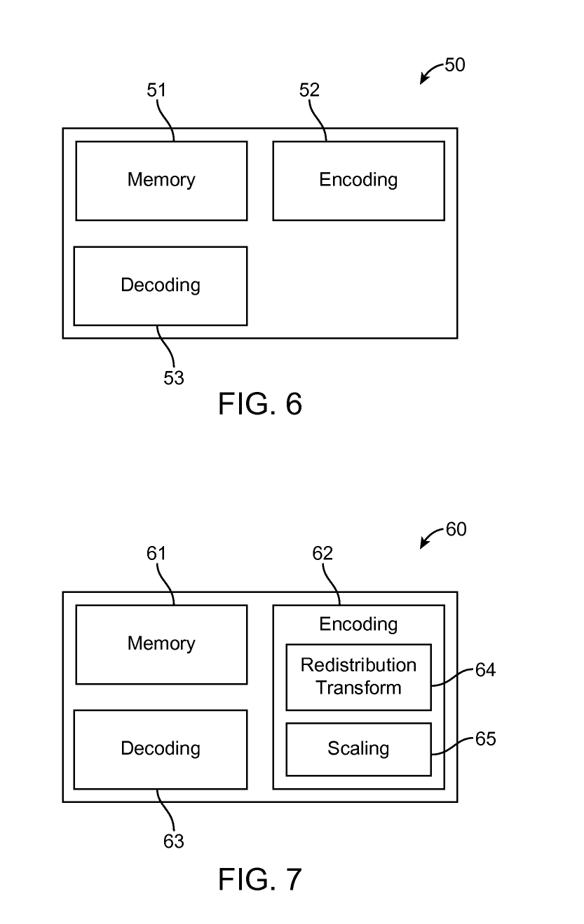

FIG. 6 illustrates a block diagram of an example terminal node 50, in accordance with an embodiment of the invention. The terminal node 50 includes a memory module 51, an encoding module 52, and a decoding module 53. The memory module 51 maintains messages previously generated and transmitted by the terminal node 50. The memory module 51 also maintains decoded information, such as decoded messages from another terminal node 50.

The encoding module 52 encodes each message generated by the terminal node 50, and transmits the encoded message to a neighboring relay node 60. In one embodiment, the encoding module 52 encodes each message generated by the terminal node 50 into a lattice codeword.

The decoding module 53 receives encoded messages from a neighboring relay node 60, and decodes each encoded message received. In one embodiment, each encoded message is a lattice codeword or a lattice codeword combination. The decoding module 53 decodes each encoded message based on information maintained in the memory module 51.

FIG. 7 illustrates a block diagram of an example relay node 60, in accordance with an embodiment of the invention. The relay node 60 includes a memory module 61, an encoding module 62, and a decoding module 63. The memory module 61 maintains messages previously broadcast by the relay node 60. The memory module 61 also maintains decoded information, such as decoded messages from neighboring nodes.

The decoding module 63 receives encoded messages from neighboring nodes, and decodes each encoded message received. In one embodiment, each encoded message is a lattice codeword or a lattice codeword combination. The decoding module 53 decodes each encoded message based on information maintained in the memory module 51.

The encoding module 62 encodes each decoded message into a new encoded message, and broadcasts the new encoded message to neighboring nodes. In one embodiment, the encoding module 62 comprises a redistribution transform unit 64 and a scaling unit 65. For each decoded message, the redistribution transform unit 64 applies a redistribution transform to the decoded message to generate an encoded message (e.g., a new lattice codeword combination). The scaling unit 65 then scales the encoded message. The encoding module 62 broadcasts the scaled encoded message to neighboring nodes.

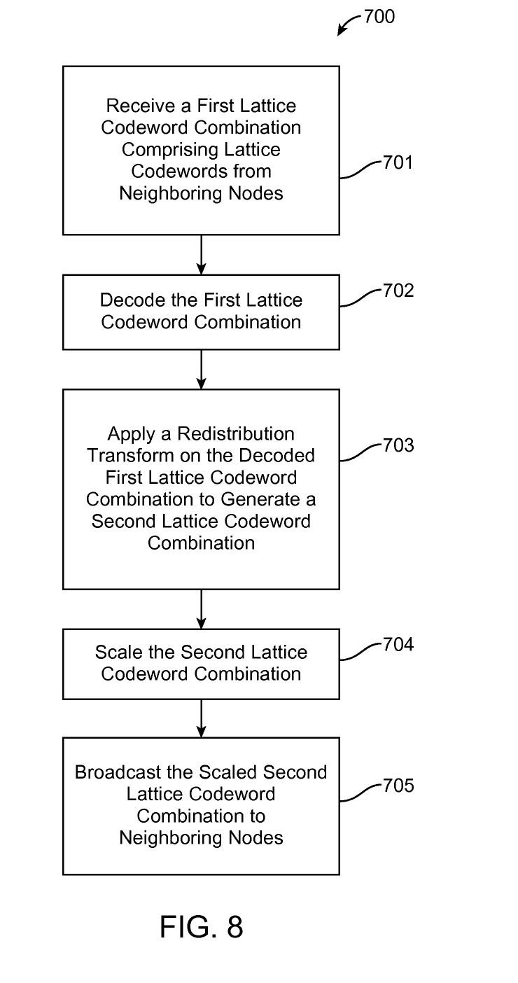

FIG. 8 illustrates an example flow chart 700 for re-encoding a decoded message in a relay node using a redistribution transform, in accordance with an embodiment. In process block 701, receive a first lattice codeword combination comprising lattice codewords from neighboring nodes. In process block 702, decode the first lattice codeword combination. In process block 703, apply a redistribution transform on the decoded first lattice codeword combination to generate a second lattice codeword combination. In process block 704, scale the second lattice codeword combination. In process block 705, broadcast the scaled second lattice codeword combination to neighboring nodes.

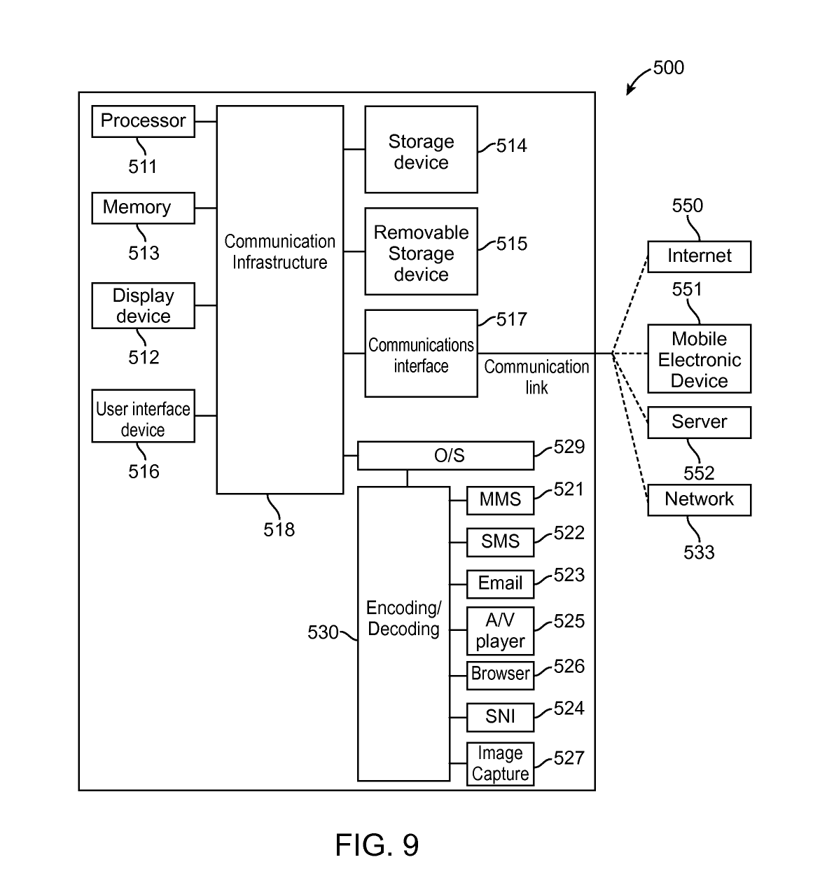

FIG. 9 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices and/or networks, such as the Internet 550, a mobile electronic device 551, a server 552, and a network 553. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

The system 500 may further include application modules as MMS module 521, SMS module 522, email module 523, social network interface (SNI) module 524, audio/video (AV) player 525, web browser 526, image capture module 527, etc.

The system 500 further includes a lattice encoding/decoding system 530 as described herein, according to an embodiment. In one embodiment, the automated security policy generation system 530 along with an operating system 529 may be implemented as executable code residing in a memory of the system 500. In another embodiment, the automated security policy generation system 530 along with the operating system 529 may be implemented in firmware.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the one or more embodiments have been described with reference to certain versions thereof; however, other versions are possible. Therefore, the spirit and scope of the appended claims should not be limited to the description of the preferred versions contained herein.

What is claimed is:

1. A method for a relay node, comprising:
receiving a first message combination comprising at least one encoded message from a first neighboring node and at least one encoded message from a second neighboring node;
decoding the first message combination based on one or more decoding constraints, wherein each decoding constraint is based on a transmission power of a neighboring node;
applying a transform to the decoded first message combination to generate a second message combination for broadcast;
scaling the second message combination based on a transmission power of the relay node and a transmission power of a neighboring node; and
simultaneously broadcasting the scaled second message combination to the first neighboring node and the second neighboring node at a symmetric rate.

2. The method of claim 1, wherein simultaneously broadcasting the scaled second message combination to the first neighboring node and the second neighboring node at a symmetric rate comprises:
the relay node simultaneously broadcasting the scaled second message combination to the first neighboring node and the second neighboring node at the same transmission rate, thereby efficiently utilizing the transmission power of the relay node.

3. The method of claim 1, wherein:
each encoded message from each neighboring node comprises a lattice codeword encoded by said neighboring node, wherein each lattice codeword is encoded based on a pair of nested lattices.

4. The method of claim 1, wherein applying a transform to the decoded first message combination to generate a second message combination for broadcast comprises:
multiplying the decoded first message combination by an integer value; and
applying a modulo operation over a scaled lattice to the decoded first message combination.

5. The method of claim 4, wherein said scaled lattice comprises a lattice scaled based on a transmission power of a neighboring node.

6. The method of claim 1, wherein each decoding constraint restricts a decoding rate of the relay node based on a transmission power of a neighboring node and a noise variance value.

7. The method of claim 6, wherein decoding the first message combination based on one or more decoding constraints comprises:
applying a modulo operation over a scaled lattice to the first message combination; and
decoding the first message combination based on said one or more decoding constraints to remove noise from said first message combination.

8. The method of claim 7, wherein said scaled lattice comprises a lattice scaled based on a transmission power of a neighboring node.

9. The method of claim 1, wherein scaling the second message combination based on a transmission power of the relay node and a transmission power of a neighboring node comprises:
scaling the second message combination based on a ratio of the transmission power of the relay node to a transmission power of a neighboring node.

10. A system, comprising:
a first terminal node and a second terminal node, wherein the terminal nodes are non-neighboring nodes; and
at least one relay node interconnecting the terminal nodes, wherein each relay node is configured for:
decoding a first message combination comprising encoded messages from neighboring nodes based on one or more decoding constraints, wherein each decoding constraint is based on a transmission power of a neighboring node;
applying a transform to the decoded first message combination to generate a second message combination for broadcast;
scaling the second message combination based on a transmission power of said relay node and a transmission power of a neighboring node; and
simultaneously broadcasting the scaled second message combination to each neighboring node at a symmetric rate.

11. The system of claim 10, wherein, for each relay node, simultaneously broadcasting the scaled second message combination to each neighboring node at a symmetric rate comprises:
said relay node simultaneously broadcasting the scaled second message combination to each neighboring node at the same transmission rate, thereby efficiently utilizing the transmission power of said relay node.

12. The system of claim 10, wherein:
each encoded message from each neighboring node comprises a lattice codeword encoded by said neighboring node, wherein each lattice codeword is encoded based on a pair of nested lattices.

13. The system of claim 10, wherein, for each relay node, applying a transform to the decoded first message combination to generate a second message combination for broadcast comprises:
multiplying the decoded first message combination by an integer value; and
applying a modulo operation over a scaled lattice to the decoded first message combination.

14. The system of claim 10, wherein said scaled lattice comprises a lattice scaled based on a transmission power of a neighboring node.

15. The system of claim 10, wherein, for each relay node, each decoding constraint restricts a decoding rate of said relay node based on a transmission power of a neighboring node and a noise variance value.

16. The system of claim 15, wherein, for each relay node, decoding the first message combination based on one or more decoding constraints comprises:
applying a modulo operation over a scaled lattice to the first message combination; and
decoding the first message combination based on said one or more decoding constraints to remove noise from said first message combination.

17. The system of claim 16, wherein said scaled lattice comprises a lattice scaled based on a transmission power of a neighboring node.

18. The system of claim 10, wherein, for each relay node, scaling the second message combination based on a transmission power of said relay node and a transmission power of a neighboring node comprises:
scaling the second message combination based on a ratio of the transmission power of said relay node to a transmission power of a neighboring node.

19. A data relaying apparatus, comprising:
a decoding module configured for decoding a first message combination based on one or more decoding constraints, wherein the first message combination comprises at least one encoded message from a first neighboring node and at least one encoded message from a second neighboring node;
a transform module configured for applying a transform to the decoded first message combination to generate a second message combination for broadcast; and
a scaling module configured for scaling the second message combination based on a transmission power of the relay node and a transmission power of a neighboring node;
wherein the scaled second message combination is simultaneously broadcast to the first neighboring node and the second neighboring node at a symmetric rate; and
wherein each decoding constraint is based on a transmission power of a neighboring node.

20. The relaying apparatus of claim 19, wherein the relaying apparatus simultaneously broadcasts the scaled second message combination to the first neighboring node and the second neighboring node at the same transmission rate, thereby efficiently utilizing the transmission power of the relaying apparatus.

21. The relaying apparatus of claim 19, wherein:
each encoded message from each neighboring node comprises a lattice codeword encoded by said neighboring node, wherein each lattice codeword is encoded based on a pair of nested lattices.

22. The relaying apparatus of claim 19, wherein applying a transform to the decoded first message combination to generate a second message combination for broadcast comprises:
multiplying the decoded first message combination by an integer value; and
applying a modulo operation over a scaled lattice to the decoded first message combination.

23. The relaying apparatus of claim 22, wherein said scaled lattice comprises a lattice scaled based on a transmission power of a neighboring node.

24. The relaying apparatus of claim 19, wherein each decoding constraint restricts a decoding rate of the relay node based on a transmission power of a neighboring node and a noise variance value.

25. The relaying apparatus of claim 24, wherein decoding the first message combination based on one or more decoding constraints comprises:
applying a modulo operation over a scaled lattice to the first message combination; and
decoding the first message combination based on said one or more decoding constraints to remove noise from said first message combination.

26. The relaying apparatus of claim 25, wherein said scaled lattice comprises a lattice scaled based on a transmission power of a neighboring node.

27. The relaying apparatus of claim 19, wherein scaling the second message combination based on a transmission power of the relay node and a transmission power of a neighboring node comprises:
scaling the second message combination based on a ratio of the transmission power of the relay node to a transmission power of a neighboring node.

28. A non-transitory computer-readable medium having instructions which when executed on a computer perform a method for a relay node, the method comprising:
receiving a first message combination comprising at least one encoded message from a first neighboring node and at least one encoded message from a second neighboring node;
decoding the first message combination based on one or more decoding constraints, wherein each decoding constraint is based on a transmission power of a neighboring node;
applying a transform to the decoded first message combination to generate a second message combination for broadcast;
scaling the second message combination based on a transmission power of the relay node and a transmission power of a neighboring node; and
simultaneously broadcasting the scaled second message combination to the first neighboring node and the second neighboring node at a symmetric rate.

29. The non-transitory computer-readable medium of claim 28, wherein:
applying a transform to the decoded first message combination to generate a second message combination for broadcast comprises:
multiplying the decoded first message combination by an integer value; and
applying a modulo operation over a scaled lattice to the decoded first message combination; and
scaling the second message combination based on a transmission power of the relay node and a transmission power of a neighboring node comprises:
scaling the second message combination based on a ratio of the transmission power of the relay node to a transmission power of a neighboring node.

30. The non-transitory computer-readable medium of claim 28, wherein decoding the first message combination based on one or more decoding constraints comprises:
applying a modulo operation over a scaled lattice to the first message combination; and
decoding the first message combination based on said one or more decoding constraints to remove noise from said first message combination.
